(19) United States
(12) Patent Application Publication
(10) Pub. No.: US 2012/0187049 A1
(43) Pub. Date: Jul. 26, 2012

(54) Method of Removing Multi-Valent Metals From Crude Oil

(75) Inventors: Tran Nguyen, Houston, TX (US); Lawrence N. Kremer, Woodlands, TX (US); Douglas J. Longtin, Pasadena, TX (US); Marc N. Lehmann, Houston, TX (US); George G. Duggan, Katy, TX (US); Lauren Wagner, Houston, TX (US); Simon C. Cornelius, Tomball, TX (US); Joseph L. Stark, Richmond, TX (US); Xiomara M. Price, League City, TX (US)

(73) Assignee: Baker Hughes Incorporated, Houston, TX (US)

(21) Appl. No.: 13/197,359

(22) Filed: Aug. 3, 2011

Related U.S. Application Data
(60) Provisional application No. 61/371,043, filed on Aug. 5, 2010.

(51) Int. Cl. C10M 177/00; B01D 21/02

(52) U.S. Cl. 210/749; 508/110

(57) ABSTRACT

Multi-valent metals, such as iron, may be removed from crude oil by introducing at least one metal removal chemical to the crude oil before, during or after the crude oil is charged to a settling tank. After mixing the metal removal chemical with the crude oil, the crude oil is kept still or held quiescent for an effective period of time to allow the metal species to settle to the bottom of the tank. Oil having reduced metal content may be removed from the top of the tank and/or metal-rich oil may be drained from the bottom of the tank or both. The crude oil having reduced metal content will cause fewer problems downstream in the refinery.

### CROSS-REFERENCE TO RELATED APPLICATION

This application claims the benefit of U.S. Provisional Patent Application No. 61/371,043 filed Aug. 5, 2010, incorporated herein by reference in its entirety.

### TECHNICAL FIELD

The present invention relates to methods and compositions for removing metals from crude oil, and more particularly relates, in one non-limiting embodiment, to methods and compositions for removing metals such as iron from crude oil in a settling tank using at least one iron removal chemical.

### BACKGROUND

In an oil refinery, the removing of metals, such as iron, from crude oil has been practiced for many years. The crude may be contaminated from several sources, including, but not necessarily limited to:
Brine contamination in the crude oil as a result of the brine associated with the oil in the ground;
Minerals, clay, silt, and sand from the formation around the oil well bore;
Metals including calcium, zinc, silicon, nickel, sodium, potassium, etc.; and
Iron sulfides and iron oxides resulting from pipeline and vessel corrosion during production, transport, and storage.

The metals present in crude oil are often in the form of metal salts and removing them is often performed in a unit called a desalter. Desalting or removing the metal salts, or at least reducing their presence, is necessary prior to further processing since these salts and other inorganic materials would otherwise cause fouling and deposits in downstream heat exchanger equipment and/or the corrosive salts would be detrimental to crude oil processing equipment. Further, some of these metals may act as poisons for the catalysts used in downstream refinery units. Effective crude oil desalting can help minimize the effects of these contaminants on the crude unit and downstream operations. Proper desalter operations may provide one or more of the following benefits to the refiner:
Reduced crude unit corrosion.
Reduced crude preheat system fouling.
Reduced potential for distillation column damage.
Reduced energy costs.
Reduced downstream process and product contamination.

Desalting also involves the resolution of the natural emulsion of water that accompanies the crude oil by creating another emulsion in which about 5 percent relative wash water is dispersed into the oil using a mix valve. The streams of desalted crude oil and effluent water are separately discharged from the desalter.

The entire desalting process is a continuous flow procedure as opposed to a batch process. Normally, chemical additives are injected before the mix valve to help resolve the oil/water emulsion in addition to the use of electrostatic coalescence. These additives effectively allow small water droplets to more easily coalesce by lowering the oil/water interfacial tension. Crude oil that contains a high percent of particulate solids can complicate the desalting process. The particulate solids, by nature, would prefer to transfer to the water phase. However, much of the solids in a crude oil from a field exists in tight water-in-oil emulsions. That is, oil-wetted solids in high concentration in the crude may help form tight oil and water emulsions that are difficult to resolve.

As mentioned, much of the solids encountered during crude oil desalting consists of iron, most commonly as particulate iron such as iron oxide, iron (II) sulfide (FeS; ferrous sulfide), etc. Other metals that are present and which may be desirably removed include, but are not necessarily limited to, calcium, zinc, silicon, nickel, sodium, potassium, and the like, and typically a number of these metals are present. Some of the metals may be present in a soluble form. The metals may be present in inorganic or organic forms. In addition to complicating the desalter operation, iron and other metals are of particular concern to further downstream processing. This includes the coking operation since iron and other metals remaining in the processed hydrocarbon yields a lower grade of coke. Removing the metals from the crude oil early in the hydrocarbon processing stages is desired to eventually yield high quality coke as well as to limit corrosion and fouling processing problems.

Several treatment approaches have been made to reduce total metal levels and these traditionally all center on the removal of metals at the desalter unit. Normally, the desalter only removes water soluble inorganic salts such as sodium or potassium chlorides. Some crude oils contain water insoluble metal organic acid salts such as calcium naphthenate and iron naphthenate, which are soluble or dispersed as fine particulate matter in the oil but not in water.

Known methods of using desalters to remove iron include that in U.S. Pat. No. 5,078,858 which involves a method of extracting iron species, such as iron naphthenate, and iron sulfides, from a liquid hydrocarbon, such as crude oil using a chelant, such as oxalic or citric acid, which is added directly to the liquid hydrocarbon and mixed therewith. Then, wash water is added to form a water-in-oil (W/O) emulsion. The emulsion is resolved, with iron laden aqueous phase being separated.

Methods of diminishing the content of soluble and insoluble forms of iron from crude are also disclosed in U.S. Pat. No. 5,080,779. In this method, crude and water soluble chelant are mixed prior to addition of wash water. After wash water addition, an emulsion is formed. After resolution of the emulsion, an iron laden water phase is separated resulting in decreased iron content in the crude. In a two-step desalting process, water soluble chelant is mixed with crude separated from the resolved emulsion emanating from the first, upstream, desalter. After such mixing, fresh wash water is added, with the so-formed crude/chelant/wash water mixture is fed to the second, downstream, desalter, for resolution. Crude separated from the second desalter has substantially diminished iron content compared to crude fed to the first desalter.

It would be desirable to develop a composition and method employing it that would cause most or all of the iron in the crude oil to settle out of the crude oil prior to the desalter.

### SUMMARY

There is provided, in one non-limiting form, a method of removing multi-valent metals from crude oil that involves charging crude oil to a settling tank where the crude oil has a first multi-valent metal concentration. The method also includes introducing a multi-valent metal removal chemical to the crude oil before, during or after the crude oil is charged to the settling tank, where the amount of multi-valent metal removal chemical is that effective to cause the multi-valent metal to settle. The method additionally includes permitting the multi-valent metal to settle to the bottom of the settling tank for a time period effective (e.g. at least two hours) where the crude oil in the top of the settling tank has a second multi-valent metal concentration that is lower than the first multi-valent metal concentration. Finally, the method additionally involves removing crude oil having the second multi-valent metal concentration from the top of the settling tank.

In another non-restrictive embodiment, there is provided a treated crude oil that includes crude oil containing a multi-valent metal and a multi-valent metal removal chemical that may be sodium silicate, trithiocarbonates, dithiocarbamates, hydropolysulfide carbonothioylbis-disodium salt, sulfonated styrene-maleic anhydride copolymer (SSMA), copolymers of acrylic acid and sulfonated hydrophobic, aromatic monomers, poly(methacrylic acid) (PMA), poly(acrylic acid) (PAA), 2-acrylamido-2-methylpropane sulfonic acid (AMPS), ethyl vinyl acetate polymer, acid catalyzed nonyl phenol resin oxyalkylate, and/or a nonionic surfactant and/or ionic surfactant. The amount of multi-valent metal removal chemical is effective to cause the multi-valent metal, e.g. iron, to settle from the crude oil toward the bottom of the tank.

### DETAILED DESCRIPTION

It has been discovered that the addition of at least one multi-valent metal removal chemical to crude oil before, during or after the crude oil is charged to a settling tank will cause the multi-valent metal species to settle to the bottom of the tank. The introduction of the chemical into the crude by itself may be sufficient mixing, or there may be an additional intentional mixing process. Subsequently the crude oil is kept still or held quiescent in the tank for enough time to allow or permit the multi-valent metal species to settle to the bottom of the tank. Clean oil may be removed from the top of the tank and/or the multi-valent metal-rich oil may be drained from the bottom of the tank. The crude oil in the top of the tank should be sufficiently low in multi-valent metal that it will cause fewer problems in the refinery and other processing downstream.

The multi-valent metals include, but are not necessarily limited to, transition metals such as iron and zinc, alkaline earth metals such as calcium and magnesium, aluminum, lead, and combinations thereof. Technically, phosphorus is a multivalent non-metal, but is a multivalent element that may in some cases be removed together with the multivalent elements from crude oil.

In one non-limiting embodiment, the removal of particulate iron is in the form of iron oxide, iron sulfide, etc. and is a specific, non-limiting embodiment of the method described herein.

By “removing” a multi-valent metal from the hydrocarbon or crude is meant any and all partitioning, sequestering, separating, transferring, eliminating, dividing, removing, dropping out of the multi-valent metal from the hydrocarbon or crude to any extent.

Suitable multi-valent metal removal chemicals include, but are not necessarily limited to, sodium silicate, trithiocarbonate, dithiocarbamate, hydropolysulfide carbonothioylbis-disodium salt, sulfonated styrene-maleic anhydride copolymer (SSMA), copolymers of acrylic acid and sulfonated hydrophobic, aromatic monomers, poly(methacrylic acid) (PMA), poly(acrylic acid) (PAA), 2-acrylamido-2-methylpropane sulfonic acid (AMPS), ethyl vinyl acetate polymer, acid catalyzed nonyl phenol resin oxyalkylate, nonionic and/or ionic surfactants and combinations thereof. One non-limiting suitable source of SSMA is VERSA-TL 3 available from Akzo Nobel; a similar product is available from Sartomer Chemical. One non-limiting suitable source of a copolymer of acrylic acid and sulfonated hydrophobic, aromatic monomers is AQUATREAT® AR 540 antiscalant available from Akzo Nobel. One non-limiting source of PMA is OPTIDOSE™ 4210 PMA available from Rohm and Haas or Dow Chemical. One non-limiting source of PAA is ACCUMER™ 1000 available from Rohm and Haas, now owned by Dow Chemical. The acid that is used to catalyze nonyl phenol resin oxyalkate may be dodecylbenzene sulfonic acid (DDBSA). Sodium silicate and the nonionic and/or ionic surfactants are water soluble and are advantageously handled and delivered using water as a solvent. The other multi-valent metal removal chemicals noted are oil soluble and may be advantageously handled and delivered using an oil based solvent. Suitable oil based solvents include, but are not necessarily limited to, mineral oil, diesel, kerosene, aromatic based solvent and the like.

Without wanting to be limited to any particular explanation, it is believed that the multi-valent metal removal chemicals function at least in part as emulsion breakers or demulsifiers. It appears that an important part of the method may be dehydration of the crude oil—that is removing the water. The multi-valent metal species may be contained in the water that settles to the bottom of the settling tank, but in any event falls to the bottom of the tank.

The nonionic surfactants and/or ionic surfactants may be used alone or may be used together with one or more of the other multi-valent metal removal chemicals where it functions as a wetting agent. Such wetting agents, which may be also called conditioners, will help the multi-valent metal removal chemical contact the ion species and interact with them so that the resulting material may be a reaction product or a complex or other associated species that settles under the influence of gravity over time. Wetting agents such as nonionic and/or ionic surfactants may also help remove iron sulfide and/or iron oxide alone or in conjunction with another iron removal chemical. Suitable nonionic and/or ionic surfactants include, but are not necessarily limited to, alkyl benzene sulfonic acids, amine neutralized alkyl benzene sulfonic acids, toluene sulfonic acid, di-octyl sulfosuccinate, sulfate ethoxylated sulfate ether and mixtures thereof.

Combinations of the multi-valent metal removal chemicals are also expected to be useful. For instance, sodium silicate may be useful together with emulsion breaking chemicals such as acid catalyzed nonyl phenol resin oxyalkylate in moving iron sulfide from the crude oil into the water phase at the bottom of tankage.

Again without desiring to be limited to any particular explanation, the treatment with sodium silicate may be the most effective for iron in the form of iron sulfide and iron oxide solids. The trithiocarbonates and dithiocarbamates may be most effective on iron that is in the form of organometallic iron compounds.

A goal of the process is to reduce the multi-valent metal content in the crude oil to an acceptable level to be processed in a refinery. In one non-limiting embodiment, the treated crude oil would be permitted to settle in the tank until a predetermined target concentration is reached. In another non-restrictive version, there may be a fixed amount of time before the crude oil must be processed in the refinery. Thus, the iron removal chemical dosage would be adjusted to accomplish yielding crude oil with the necessary low iron content threshold in the time required. In a non-limiting example, when acid catalyzed nonyl phenol resin oxyalkylate is used as the multi-valent metal removal chemical, the dosage may be increased from 5 ppm to 12 ppm, based on the crude oil, in order to complete the settling in 12 hours instead of 24 hours. However, it should be realized that the exact dosage will be very dependent upon the particular crude oil and the needs of the particular refinery. Optimum dosages will have to be developed with experience and would be very difficult to predict in advance.

Nevertheless, in order to give some idea about useful dosage levels for certain of the multi-valent metal removal chemical, non-limiting representative dosage levels for certain iron removal chemicals will be outlined, all based on the crude oil treated. For instance, when emulsion breakers such as acid catalyzed nonyl phenol resin oxyalkylate are used, treatment may range from about 3 ppm independently to about 100 ppm, in another non-limiting embodiment from about 10 independently to about 25 ppm, where “independently” means that any lower threshold may be combined with any upper threshold. Sodium silicate may be employed in a proportion from about 100 independently to about 20,000 ppm, alternatively from about 500 independently to about 1,500 ppm. When a nonionic and/or ionic surfactant is used alone or as a wetting agent, it may be employed in a proportion of from about 0.5 ppm to about 10 ppm.

Similarly, when trithiocarbonate is employed, the dosage may range from about 1 to about 10,000 ppm. When the iron removal chemical is dithiocarbamate, the proportion may range from about 1 to about 10,000 ppm. When the multi-valent metal removal chemical is sulfonated styrene-maleic anhydride copolymer (SSMA), the dosage may range from about 1 to about 60 ppm. When the multi-valent metal removal chemical is a copolymer of acrylic acid and sulfonated hydrophobic, aromatic monomers, the dosage may range from about 1 to about 60 ppm, When the multi-valent metal removal chemical is poly(methacrylic acid) (PMA), the concentration may be from about 1 to about 60 ppm, and may be from about 1 to about 100 ppm when the multi-valent metal removal chemical is hydropolysulfide carbonothioylbis-disodium salt. When the multi-valent metal removal chemical is poly(acrylic acid) (PAA), the dosage may range from about 1 to about 60 ppm. When the multi-valent metal removal chemical is 2-acrylamido-2-methylpropane sulfonic acid (AMPS), the proportion may range from about 1 to about 60 ppm. Finally, when the multi-valent metal removal chemical is an ethyl vinyl acetate polymer, the proportion may range from about 1 to about 200 ppm.

In another non-limiting embodiment the multi-valent metal removal chemical reacts stoichiometrically with the multi-valent metal species to be removed. Thus an equivalent amount of multi-valent metal removal chemical must be added compared to the concentration of multi-valent metal species to be removed. A slight excess of the multi-valent metal removal chemical will ensure that the reaction, chelating or other association or complexing of the multi-valent metal removal chemical with the multi-valent metal species goes to completion. In one non-limiting embodiment, the amount of multi-valent metal removal chemical is stoichiometric with the amount of multi-valent metal present, or greater than stoichiometric. For economic reasons the refinery may chose to leave some of the multi-valent metal species in the crude at an acceptably low level of contamination of the crude. In those cases the treatment level of the multi-valent metal removal chemical may be correspondingly reduced.

Settling agents may also be useful in facilitating the settling of various multi-valent metal species to the bottom of the settling tank. Suitable settling agents include, but are not necessarily limited to alkyoxylated phenolic resins; oxyalkylated polyamines, including, but not necessarily limited to ethoxylated and/or propoxylated 1,2-ethanediamine, N1-(2-aminoethyl)-N2-[2-[(2-aminoethyl)-amino]ethyl]-, and polymers with 2-methyloxirane and oxirane; oxyalkylated alkanol amines, including, but not necessarily limited to, ethoxylated and/or propoxylated 1,3-propanediol, 2-amino-2-(hydroxymethyl)-1,3-propanediol, and again polymers with 2-methyloxirane and oxirane; Mannich reaction condensation products of alkyl phenols and polyamines and mixtures thereof. Amines suitable to make these settling agents may range from ethylene diamine to tetraethylene pentamine or higher. Suitable alkyl phenols for use in these settling agents may be those having one or more R group substituent, where R may be defined from C1 to C36 linear, branched, cyclic alkyl groups and combinations of these. The amounts of such settling agents may range from about 3 ppm independently to about 2000 ppm; alternatively from about 100 ppm independently to about 250 ppm.

In another non-limiting embodiment, the pH of the crude oil being treated is adjusted to be about 8 or higher by the introduction of one or more of the multi-valent metal removal chemicals. Alternatively, the pH may be lowered by the introduction of a different acidic multi-valent metal removal chemical than those which would raise the pH, for instance by a mineral acid, and/or an organic acid. The pH range may be lowered to between about 2, alternatively to about 3 and in another non-limiting embodiment to about 4, particularly when removing FeS. Suitable organic acids include, but are not necessarily limited to, glycolic acid, lactic acid, malic acid, citric acid, formic acid, acetic acid, and the like, and mixtures thereof. These organic acids may also be used together with a FeS dispersant, such as 3-(methylacrylamido)propyl trimethyl ammonium chloride (MAPTAC) copolymer that would water-wet the FeS and cause it to settle. These acids may be dissolved in water to facilitate injection into crude oil.

It is expected that the water-soluble hydroxyacids will be used together with other additives including, but not necessarily limited to, corrosion inhibitors, demulsifiers, pH adjusters, metal chelants, scale inhibitors, hydrocarbon solvents, and mixtures thereof, in a commercial process. Metal chelants are compounds that complex with iron to form chelates. The resulting chelates may be more soluble in water than in hydrocarbons. In particular, organic acids may be used since metal removal is best accomplished at an acidic pH. The use of combinations of multi-valent metal removal chemicals and organic and/or mineral acids may give the best economics in a commercial application. Suitable acids were previously listed. As noted, in one non-limiting embodiment, the method is practiced ahead of a refinery desalting process that involves washing the crude emulsion with wash water.

The method includes, but is not necessarily limited to, introducing an additive to the mud wash to drop out, partition, precipitate or otherwise remove metals by dissolving the emulsion band. The mudwash system removes sediment from the bottom of a desalter. The mud wash is a water stream introduced to the settling tank. Suitable additives include, but are not necessarily limited to, organic acids, demulsifiers, pH adjusters, metal chelants, solution chemistry, emulsion polymer chemistry, etc.

The iron removal chemical of the method herein is introduced into the crude oil before, during or after the crude oil is charged to the settling tank. This introduction may be sufficient to mix the iron removal chemical sufficiently with the crude oil or there may be a separate mixing step or apparatus. For instance, the multi-valent metal removal chemical may be introduced into the crude oil prior to a mix valve or static mixer before both are charged to a settling tank. In a non-restrictive alternative, the multi-valent metal removal chemical and crude oil may be mixed in the settling tank, such as by using an impeller. However, at some point in the method the crude oil containing the multi-valent metal removal chemical is kept still or maintained quiescent for a sufficient period of time to permit the multivalent metal species treated with the multi-valent metal removal chemical to settle to the bottom of the tank. In most embodiments, it is expected that the bottom of the tank contains a water layer that is a consequence of dehydrating the crude oil. In one non-limiting embodiment this settling time is at least 2 hours, in one non-limiting embodiment at least 12 hours; alternatively at least 24 hours; in a different, non-restrictive version at least 48 hours; in another non-restrictive version this time period is 72 hours. One typical settling time is from about 12 to about 48 hours.

It is acceptable, of course, that in the practice of this method all of the multi-valent metal settles to the bottom of the tank. In another non-limiting embodiment, 25% or less of the original multi-valent metal is present in the crude oil after metal settling or desalting, alternatively 20% or less multi-valent metal remains, in another non-restrictive version only 10% or less remains. In some cases the refinery may chose to leave higher percentages of multi-valent metal contaminants in the crude if the detrimental effects are judged to be economically acceptable.

The method herein may be practiced without or in the absence of a desalter, countercurrent extraction, and/or an intentionally created emulsion. Stated another way, the settling tank is not a desalter in the conventional sense, although multi-valent metal salts may settle to the bottom of the tank and are removed from the upper level of the crude which thus has a lower concentration of the multi-valent metal salts. Also, the crude oil may contain a naturally occurring emulsion when it is introduced to the settling tank, but no additional water, that is, there is an absence of added water, to intentionally create an emulsion or to increase any emulsion already present is introduced. However, as mentioned, it is expected that in many alternative embodiments, this method will be practiced upstream of a desalter, and that the crude oil having greater multi-valent metal concentration removed from the bottom of the settling tank is sent to the desalter.

The invention will be illustrated further with reference to the following Examples, which are not intended to limit the invention, but instead illuminate it further.

### EXAMPLES

A number of multi-valent metal removal chemical candidates are presented for consideration in Table I, along with suggested dosages.

TABLE I
Multi-Valent Metal Removal Chemical Candidates

| | | | | | | Possible |
|---|---|---|---|---|---|---|
| Ex. | Name | Chemistry | Abbrev. | Form | Function | Dosage, ppm |
| 1 | VERSA TL-3 | SSMA | SSMA | Dry; convert | Dispersant | 5 |
| | | | | to a solution | | |
| | | | | between about | | |
| | | | | 20-about 45 wt % | | |
| 2 | AQUATREAT | Copolymer of | AA/SM | Liquid | Dispersant | 5 |
| | AR 540 | acrylic acid and | | | | |
| | | sulfonated monomer | | | | |
| 3 | OPTIDOSE ™ | PMA | PMA | Liquid | Dispersant | 5 |
| | 4210 | | | | | |
| 4 | Accumer 1000 | PAA | PAA | Liquid | pH modifier | 5 |
| 5 | Y9BH1330 | Organic acid | M | Liquid | pH modifier | 40 |
| 6 | Y9BH1346 | Organic acid | G | Liquid | pH modifier | 40 |
| 7 | BPR 23025 | Demulsifier | Demul | Liquid | Demulsifier | 10 |
| 8 | BPR 27210 | Wetting agent | WA | Liquid | Wetting agent | 10 |
| 9 | SRW 4850 | organic | C | Liquid | pH modifier | 40 |
| 10 | 98BH210B | phenol resin | | Liquid | | 10 |
| | | blend | | | | |

BPR 27210 is an amine wetting agent having about 120 moles of ethylene oxide and propylene oxide; it is described in U.S. Pat. No. 5,176,847 as one of three components of an emulsion breaker formula. This patent is incorporated herein by reference in its entirety.

Laboratory data for select candidates are presented in Table II. The indicated candidate was introduced to the same crude oil for all Examples at the indicated concentration and mixed with the crude. The treated crude was permitted to settle for 24 hours. A sample was taken from the top and from the bottom of the crude. It may be seen that in every case more iron settled in the presence of an iron removal chemical as compared with the blank crude where no chemical was added.

TABLE II
Performance of Candidates on Fe Removal with Pretreatment

| | | | | Fe count, | Fe count, |
|---|---|---|---|---|---|
| | | | | ppm from | ppm, from |
| Ex. | Sample | Chemical | Dosage | top | bottom |
| 11 | Blank Crude | None | None | 13 | 25 |
| 12 | BPR 23025R | Blends of | 20 ppm | 8.8 | 15 |
| | | Alkyloxylated | | | |
| | | Alkyl Phenol | | | |
| | | Resins | | | |
| 13 | BPR 27141 | Blends of | 20 ppm | 7.3 | 27 |
| | | Alkyloxylated | | | |
| | | Alkyl Phenol | | | |
| | | Resins | | | |
| 14 | Y9BH1347 | Blends of | 20 ppm | 6.1 | 24 |
| | | Alkyloxylated | | | |
| | | Alkyl Phenol | | | |
| | | Resins | | | |
| 15 | XERIC 7005 | Resin | 20 ppm | 6.4 | 15 |
| 16 | XERIC 7000 | Resin | 20 ppm | 8.2 | 19 |
| 17 | BPR 27210 | Nonionic/ionic | 20 ppm | 5.9 | 10 |
| | | surfactant | | | |
| 18 | BPW 75750 | sodium | 60 ppm | 6.9 | 8.9 |
| | | trithio- | | | |
| | | carbonate | | | |
| 19 | BPW 75823 | sodium | 60 ppm | 5.3 | 10 |
| | | dithio- | | | |
| | | carbamate | | | |
| 20 | BPR 23595 | sodium | 1 vol % | 5 | 10 |
| | | metasilicate | | | |
| | | solution | | | |
| 21 | Y10BH1399 | hydropoly- | 60 ppm | 6.4 | 11 |
| | | sulfide | | | |
| | | carbonothioyl- | | | |
| | | bisdisodium | | | |
| | | salt | | | |
| 22 | TOLAD 3030 | Ethyl vinyl | 50 ppm | 7.8 | 8.6 |
| | | acetate | | | |
| | | polymer | | | |

BPR 23595 is a sodium metasilicate solution which may be used in a concentration ranging from about 1000 ppm to about 30,000 ppm.

Laboratory data for select candidates are presented in Table III for multi-valent metals other than iron and for phosphorus. These data were obtained by the same procedure as were the data presented above in Table II. Dosages were as shown in Table II and all counts were taken from the top of the tank and are expressed as ppm.

TABLE III
Performance of Candidates on Multi-Valent Metal
Removal and Phosphorus Removal with Pretreatment

| Ex. | Sample | Ca | Mg | Zn | Al | Pb | P |
|---|---|---|---|---|---|---|---|
| 11 | Blank Crude | 12 | 6.8 | 0.7 | 9.9 | 1.3 | 2.8 |
| 12 | BPR 23025R | 4 | 4.8 | 0.4 | 2.3 | 0.6 | 2 |
| 13 | BPR 27141 | 2.5 | 5.2 | 0.5 | 2.2 | 0.6 | 1.7 |
| 14 | Y9BH1347 | 2.4 | 5.2 | 0.3 | 2.1 | 0.8 | 1.9 |
| 15 | XERIC 7005 | 2.7 | 4.9 | 0.4 | 1.8 | 0.6 | 1.9 |
| 16 | XERIC 7000 | 3.3 | 5 | 0.3 | 1.9 | 0.6 | 2.2 |
| 17 | BPR 27210 | 3.3 | 4 | 0.3 | 1.6 | 0.7 | 2.2 |
| 18 | BPW 75750 | 3 | 5.6 | 0.3 | 2.8 | 1.2 | 2.1 |
| 19 | BPW 75823 | 2.4 | 4 | 0.2 | 1.3 | 0.7 | 2 |
| 20 | BPR 23595 | 3 | 5 | 0.3 | 2 | 0.5 | 1.8 |
| 21 | Y10BH1399 | 2.4 | <.3 | 0.2 | <.3 | 1 | 2.2 |
| 22 | TOLAD 3030 | 3 | 0.3 | 0.3 | 0.3 | 0.8 | 2.3 |

In the foregoing specification, the invention has been described with reference to specific embodiments thereof, and has been demonstrated as effective in settling multi-valent metal from crude oil in bench scale desalting testing, as non-limiting examples. However, it will be evident that various modifications and changes can be made thereto without departing from the broader spirit or scope of the invention as set forth in the appended claims. Accordingly, the specification is to be regarded in an illustrative rather than a restrictive sense. For example, specific multi-valent metal removal chemicals, wetting agents, settling agents and combinations thereof with or without mineral and/or organic acids, other than those specifically exemplified or mentioned, or in different proportions, falling within the claimed parameters, but not specifically identified or tried in a particular application to settle multi-valent metal species, are within the scope of this invention. Similarly, it is expected that the inventive compositions will find utility as iron removal or iron settling compositions for other fluids besides crude oil.

The terms “comprises” and “comprising” in the claims should be interpreted to mean including, but not limited to, the recited elements.

The present invention may suitably comprise, consist or consist essentially of the elements disclosed and may be practiced in the absence of an element not disclosed. For instance, a method of removing multi-valent metal from crude oil within the descriptions herein may consist of or consist essentially of charging crude oil to a settling tank, where the crude oil has a first concentration; introducing at least one multi-valent metal removal chemical to the crude; permitting the multi-valent metal to settle to the bottom of the tank, where the crude that remains at the top of the tank has a second multi-valent metal concentration lower than the first multi-valent metal concentration; and removing the crude oil with the second, lower concentration from the top of the tank. Similarly, a treated crude oil may consist of or consist essentially of crude oil, at least one multi-valent metal and one or more of the multi-valent metal removal chemicals recited in the claims, which crude oil alternatively may or may not also consist of or consist essentially of a wetting agent.

What is claimed is:

1. A method of removing multi-valent metal from crude oil comprising:
charging crude oil containing multi-valent metal to a settling tank where the crude oil has a first multi-valent metal concentration;
introducing a multi-valent metal removal chemical to the crude oil before, during or after the crude oil is charged to the settling tank, where the amount of multi-valent metal removal chemical is that effective to cause the multi-valent metal to settle;
permitting the multi-valent metal to settle to the bottom of the settling tank for a time period effective that the crude oil in the top of the settling tank has a second multi-valent metal concentration lower than the first multi-valent metal concentration; and
removing crude oil having the second multi-valent metal concentration from the top of the settling tank.

2. The method of claim 1 where the multi-valent metal removal chemical is selected from the group consisting of trithiocarbonates, dithiocarbamates, hydropolysulfide carbonothioylbis-disodium salt, sulfonated styrene-maleic anhydride copolymer (SSMA), copolymers of acrylic acid and sulfonated monomers, poly(methacrylic acid) (PMA), poly(acrylic acid) (PAA), 2-acrylamido-2-methylpropane sulfonic acid (AMPS), ethyl vinyl acetate polymer, acid catalyzed nonyl phenol resin oxyalkylate, nonionic surfactants, ionic surfactants and combinations thereof.

3. The method of claim 2 where the multi-valent metal removal chemical is selected from the group consisting of trithiocarbonates, dithiocarbamates, hydropolysulfide carbonothioylbis-disodium salt, sulfonated styrene-maleic anhydride copolymer (SSMA), copolymers of acrylic acid and sulfonated monomers, poly(methacrylic acid) (PMA), poly(acrylic acid) (PAA), 2-acrylamido-2-methylpropane sulfonic acid (AMPS), ethyl vinyl acetate polymer, acid catalyzed nonyl phenol resin oxyalkylate, and the method further comprises introducing a wetting agent to the settling tank before, during or after the crude oil is charged to the settling tank, where the wetting agent is selected from the group consisting of nonionic surfactants, ionic surfactants, and combinations thereof.

4. The method of claim 1 where the multi-valent metal removal chemical and its effective amount is selected from the group consisting of:
about 1 to about 10,000 ppm trithiocarbonate,
about 1 to about 10,000 ppm dithiocarbamate,
about 1 to about 60 ppm sulfonated styrene-maleic anhydride copolymer (SSMA),
about 1 to about 60 ppm copolymers of acrylic acid and sulfonated hydrophobic, aromatic monomers,
about 1 to about 60 ppm poly(methacrylic acid) (PMA),
about 1 to about 60 ppm poly(acrylic acid) (PAA),
about 1 to about 60 ppm 2-acrylamido-2-methylpropane sulfonic acid (AMPS),
about 1 to about 100 ppm hydropolysulfide carbonothioylbis-disodium salt,
about 1 to about 200 ppm ethyl vinyl acetate polymer,
about 3 to about 100 ppm acid catalyzed nonyl phenol resin oxyalkylate,
about 0.5 to about 10 ppm nonionic and or ionic surfactant and
combinations thereof;
wherein the concentration is based upon the crude oil.

5. The method of claim 1 where the pH of the crude oil is adjusted to be about 8 or higher by the introduction of the multi-valent metal removal chemical.

6. The method of claim 1 where the pH of the crude oil is lowered by the introduction of a chemical selected from the group consisting of multi-valent metal iron removal chemical, a mineral acid, an organic acid, and combinations thereof, where the organic acid is selected from the group consisting of glycolic acid, lactic acid, malic acid, citric acid, and combinations thereof.

7. The method of claim 1 where the time period is at least 2 hours.

8. The method of claim 1 further comprising dehydrating the crude oil.

9. The method of claim 1 further comprising introducing at least one demulsifier before, during or after the crude oil is charged to the settling tank.

10. The method of claim 1 further comprising adding a dispersant to water-wet the multi-valent metal in the crude oil.

11. The method of claim 1 further comprising mixing the multi-valent metal removal chemical with the crude oil.

12. A method of removing multi-valent metal from crude oil comprising:
charging crude oil containing multi-valent metal to a settling tank where the crude oil has a first multi-valent metal concentration;
introducing a multi-valent metal removal chemical to the crude oil before, during or after the crude oil is charged to the settling tank, where the amount of multi-valent metal removal chemical is that effective to cause the multi-valent metal to settle, and where the multi-valent metal removal chemical is selected from the group consisting of trithiocarbonates, dithiocarbamates, hydropolysulfide carbonothioylbis-disodium salt, sulfonated styrene-maleic anhydride copolymer (SSMA), copolymers of acrylic acid and sulfonated monomers, poly(methacrylic acid) (PMA), poly(acrylic acid) (PAA), 2-acrylamido-2-methylpropane sulfonic acid (AMPS), ethyl vinyl acetate polymer, acid catalyzed nonyl phenol resin oxyalkylate, nonionic surfactants, ionic surfactants and combinations thereof;
permitting the multi-valent metal to settle to the bottom of the settling tank for at least two hours so that the crude oil in the top of the settling tank has a second multi-valent metal concentration lower than the first multi-valent metal concentration; and
removing crude oil having the second multi-valent metal concentration from the top of the settling tank.

13. The method of claim 12 where the multi-valent metal removal chemical and its effective amount is selected from the group consisting of:
about 1 to about 10,000 ppm trithiocarbonate,
about 1 to about 10,000 ppm dithiocarbamate,
about 1 to about 60 ppm sulfonated styrene-maleic anhydride copolymer (SSMA),
about 1 to about 60 ppm copolymers of acrylic acid and sulfonated hydrophobic, aromatic monomers,
about 1 to about 60 ppm poly(methacrylic acid) (PMA),
about 1 to about 60 ppm poly(acrylic acid) (PAA),
about 1 to about 60 ppm 2-acrylamido-2-methylpropane sulfonic acid (AMPS),
about 1 to about 100 ppm hydropolysulfide carbonothioylbis-disodium salt,
about 1 to about 200 ppm ethyl vinyl acetate polymer,
about 3 to about 100 ppm acid catalyzed nonyl phenol resin oxyalkylate,
about 0.5 to about 10 ppm nonionic and/or ionic surfactant and
combinations thereof;
wherein the concentration is based upon the crude oil.

14. A treated crude oil comprising: crude oil containing multi-valent metal and a multi-valent metal removal chemical selected from the group consisting of trithiocarbonates, dithiocarbamates, hydropolysulfide carbonothioylbis-disodium salt, sulfonated styrene-maleic anhydride copolymer (SSMA), copolymers of acrylic acid and sulfonated monomers, poly(methacrylic acid) (PMA), poly(acrylic acid) (PAA), 2-acrylamido-2-methylpropane sulfonic acid (AMPS), ethyl vinyl acetate polymer, acid catalyzed nonyl phenol resin oxyalkylate, nonionic surfactants, ionic surfactants and combinations thereof, where the amount of iron removal chemical is effective to cause the multi-valent metal to settle from the crude oil over a time period.

15. The treated crude oil of claim 14 where the effective amount of multi-valent metal removal chemical is selected from the group consisting of the following when the multi-valent metal removal chemical is as indicated:
about 1 to about 10,000 ppm trithiocarbonate,
about 1 to about 10,000 ppm dithiocarbamate,
about 1 to about 60 ppm sulfonated styrene-maleic anhydride copolymer (SSMA),
about 1 to about 60 ppm copolymers of acrylic acid and sulfonated hydrophobic, aromatic monomers,
about 1 to about 60 ppm poly(methacrylic acid) (PMA),
about 1 to about 60 ppm poly(acrylic acid) (PAA),
about 1 to about 60 ppm 2-acrylamido-2-methylpropane sulfonic acid (AMPS),
about 1 to about 100 ppm hydropolysulfide carbonothioylbis-disodium salt,
about 1 to about 200 ppm ethyl vinyl acetate polymer,
about 3 to about 100 ppm acid catalyzed nonyl phenol resin oxyalkylate,
about 0.5 to about 10 ppm nonionic and/or ionic surfactant and
combinations thereof;
wherein the concentration is based upon the crude oil.

16. The treated crude oil of claim 14 further comprising from about 0.5 to about 10 ppm of the nonionic surfactant and/or ionic surfactant.

17. The treated crude oil of claim 14 further comprising a chemical selected from the group consisting of the multi-valent metal removal chemical, a mineral acid, an organic acid, and combinations thereof, where the organic acid is selected from the group consisting of glycolic acid, lactic acid, malic acid, citric acid, and combinations thereof in an amount effective to lower the pH of the crude oil.

18. The treated crude oil of claim 14 where the composition further comprises at least one demulsifier.

19. The treated crude oil of claim 14 further comprising a dispersant configured to water-wet the multi-valent metal in the crude oil.

20. The treated crude oil of claim 14 where the multi-valent metal is iron.
